(19) United States
(12) Patent Application Publication
(10) Pub. No.: US 2014/0358585 A1
(43) Pub. Date: Dec. 4, 2014

(54) METHOD AND APPARATUS FOR DATA RECORDING, TRACKING, AND ANALYSIS IN CRITICAL RESULTS MEDICAL COMMUNICATION

(71) Applicant: Bruce REINER, Berlin, MD (US)

(72) Inventor: Bruce REINER, Berlin, MD (US)

(21) Appl. No.: 14/293,238

(22) Filed: Jun. 2, 2014

Related U.S. Application Data
(60) Provisional application No. 61/831,015, filed on Jun. 4, 2013.
(60) Provisional application No. 61/892,669, filed on Oct. 18, 2013.

(51) Int. Cl. G06F 19/00; G06F 17/30

(52) U.S. Cl. CPC G06F 19/322; G06F 17/30309; G06F 19/3425
USPC 705/3

(57) ABSTRACT

The present invention relates to an apparatus and method for implementing a medical critical results communication, including: receiving an identification and a classification of a finding of criticality on a patient; creating and transmitting a critical results communication to a recipient by electronic methods; receiving and storing an acknowledgement from the recipient that the critical results communication was received; receiving and storing feedback and/or the initiation of clinical intervention and a follow-up action from the recipient, and transmitting same to the health care provider sender; receiving and storing diagnostic confirmation from the recipient and/or the healthcare provider sender; performing an analysis of critical results data, and performing a compliance analysis with stored established medical standards; and providing the critical results data analysis and the compliance analysis to at least the health care provider sender.

### CROSS-REFERENCE TO RELATED APPLICATIONS

The present application claims priority to U.S. Provisional Patent Application No. 61/831,015 filed Jun. 4, 2013, and U.S. Provisional Patent Application No. 61/892,669, filed Oct. 18, 2013, the contents of all of which are herein incorporated by reference in their entirety.

### BACKGROUND OF THE INVENTION

1. Field of the Invention

The present invention relates to a system and method of automating and customizing a standardized data recording, tracking, and analysis in a critical results medical communication.

2. Description of the Related Art

Failure in communication between healthcare personnel has been reported to account for over 60% of root causes of sentinel events reported to the Joint Commission on Accreditation of Healthcare Organizations (JCAHO) and has prompted repeated calls from the Institute of Medicine for redesigning and error-proofing healthcare delivery in order to improve communication and patient safety. In radiology, communication failures are particularly common and are a leading cause of medical malpractice as well as dissatisfaction among referring physicians. Despite so much negativity surrounding conventional radiology reporting and communication practice, innovation in practice and technology has been lacking.

The American College of Radiology has defined three (3) categories of radiology critical results including emergent, discrepant, and unexpected findings, and requires the interpreting physician (i.e., radiologist) to expedite report delivery in a manner that ensures timely receipt of the findings. The method of communication is largely left to the discretion of the radiologist, as long as “timely receipt” is ensured and documented. In the absence of specific and standardized communication standards, institutions and practitioners are often left to their own devices, which can lead to differing expectations and practices on the part of interpreting radiologists and referring clinicians. In the event that an adverse clinical outcome does result and communication is determined to be a contributing factor, contradictory claims are often made by involved radiologists and clinicians; as to the method, content, and timeliness of communication. In the absence of objective and reproducible data, establishing causality of the communication error is often impossible and this leads to the potential for repeating past mistakes.

At the same time healthcare providers are subjected to data overload, service requirements are consistently increasing with providers asked to provide timelier service. From a reporting standpoint, report turnaround times are now being measured in hours (or even minutes) rather than days, with the adoption of speech recognition technology and teleradiology. While these technological and practice advances result in radiology report data being readily and almost instantaneously accessible after exam completion, the reality is that long periods of time often transpire before the data is reviewed and acted upon by referring clinicians. With the abundance of multi-disciplinary data consumed by a physician in the course of everyday practice, it is not unusual for a physician to delay or even overlook data from a given radiology report. In these circumstances, the limiting factor is not the radiology report “turnaround time”, but instead the radiology report “action time”. This “action time” can be defined from the time of order entry to the time clinical action takes place based upon the report findings. While “action time” delays for routine or expected report findings may not necessarily be time urgent, delays associated with critical results may often be associated with increased morbidity and/or mortality. This has led to the creation of critical results reporting requirements, with the stated goal of ensuring that critical findings contained within the radiology report are communicated and acted upon in a timely fashion. But given the current state of data overload (and data fatigue), existing critical results communication strategies do not appear to be accomplishing their stated goals.

The answer to this issue in large part varies in accordance with the specific nature of the critical finding, institutional standards, workload and state of mind of the involved parties (i.e., interpreting radiologist and referring clinician), technology in use, method of communication employed, and degree of accountability. In many circumstances, the involved parties are too busy, frustrated, or preoccupied to personally engage in communication. As a result, the radiologist or clinician may often delegate communication responsibilities to third parties (e.g., nurse, clerical staff, and technologist) who often lack detailed knowledge and/or understanding of the findings being communicated. At the same time, the method of communication used by the radiologist may often consist of a hand written note, which has the potential to be misread, leading to error. The end result is that the communication may have taken place in theory, but the resulting clinical actions lacked in timeliness and/or accuracy. In the proverbial sense, the “operation was a success”, but the outcome was a failure.

While attempts have been made to mandate direct physician-to-physician communication, a mandate is often hard to enforce due to time and availability constraints. Physicians are often unwilling to wait for prolonged periods on the telephone and as a result either defer to colleagues or computers. With the advent of computers throughout medical practice, attempts have been made to utilize computer-mediated communication (CMC) as a means to facilitate prompt and targeted task-oriented interactions. In addition, CMC offers an additional advantage of eliminating the requirement that critical results be read back by the healthcare worker when communication takes place by telephone. In theory, CMC addresses many of these methodological and outsourcing concerns, and also provides the added benefit of data documentation. In reality, however, CMC is often unsuccessful due to the lack of receipt acknowledgment and follow through on the part of the referring clinician. Data overload is believed to be a principle factor accounting for these failures, along with the excessive number of computerized alerts which are regularly encountered.

The end result is that existing communication strategies often fall short of their intended goals, and this perpetuates the potential for communication errors and deficient clinical outcomes. New strategies are required which can overcome existing deficiencies but not overload already stressed human resources.

Accordingly, the object of the present invention is the creation of a computerized method and apparatus to standardize communication databases which longitudinally record, track, and analyze all critical results communications; while simultaneously creating qualitative and quantitative accountability.

### SUMMARY OF THE INVENTION

The present invention relates to a system and method of automating and customizing a standardized data recording, tracking, and analysis in a critical results medical communication.

In one embodiment, the method includes receiving an identification and a classification of a finding of criticality on a patient, from a health care provider sender, and storing the identification and the classification of the finding in a database of a computer system; creating a critical results communication in the database, using a processor of the computer system; transmitting the critical results communication to a recipient by a predetermined electronic mode of communication using the computer system; receiving an acknowledgement from the recipient that the critical results communication was received, and storing the acknowledgement in the database; receiving feedback and/or initiation of clinical intervention and a follow-up action from the recipient, storing the feedback and/or initiation of clinical intervention and the follow-up action in the database; transmitting the feedback and/or initiation of clinical intervention and follow-up action to the health care provider sender in a response from the recipient; receiving diagnostic confirmation from the recipient and/or the healthcare provider sender, regarding the patient, and storing the diagnostic confirmation in the database; performing an analysis of critical results data in the database using the processor, and performing an analysis of compliance with stored established medical standards; and providing the critical results data analysis and the compliance analysis to the at least health care provider sender.

In another embodiment, the method includes receiving a request from the recipient and arranging for additional consultation with at least one other health care provider regarding the patient.

In yet another embodiment, the method includes incorporating medical imaging data into the critical results communication.

In yet another embodiment, the method includes customizing data presentation of the medical imaging data for each recipient tied to authentication and identification of each recipient.

In yet another embodiment, the method includes time stamping transmission of said critical results communication; and recording said criticality and an urgency of said finding on said patient, methods of data transmission to and from said recipient, and identities of said health care provider sender and said recipient, in said database.

In yet another embodiment, the authentication and identification is obtained by biometrics.

In yet another embodiment, the method includes instituting an escalation communication pathway when the recipient does not acknowledge receipt within a predetermined time period.

In yet another embodiment, information on the recording of the criticality and the urgency of the finding, and on the feedback and/or initiation of clinical intervention and the follow-up action from the recipient, or the arrangement for additional consultation, is included in the critical results communication and response from the recipient.

In yet another embodiment, the method includes linking, using the processor, follow-up action from the recipient with resulting orders from the clinician, such that the recipient may review and approve of the resulting orders.

In yet another embodiment, the method further includes issuing another critical results communication via an electronic mode of communication, when the resulting orders are approved by the recipient; and linking, using the processor, the medical imaging data with another critical results communication.

In yet another embodiment, the critical results communication is activated by the processor upon a predetermined threshold of criticality of the finding.

In yet another embodiment, the critical results communication includes mandatory standardized data fields, the data fields include the finding, the classification, the urgency, the follow-up action, and an anatomic location.

In yet another embodiment, the method includes adding non-standardized data or linking ancillary data, to the critical results communication.

In yet another embodiment, the method includes instituting a technical escalation pathway when technical issues arise in the transmission of the critical results communication.

In yet another embodiment, the critical results data analysis is performed in performed in real-time, and the real-time critical results data analysis is used to create customizable interventions, including at least real-time modifications to the escalation communication pathway.

In yet another embodiment, the method includes integrating a standardized system for documenting understanding of the critical results communication, including providing a plurality of responses for the recipient regarding understanding of the critical results communication.

In yet another embodiment, the method includes integrating a consultation tool into workflow of an end user, commensurate with individual preferences and the criticality of the critical results data.

In yet another embodiment, the consultation tool requires completion of the additional consultation before any computer-based actions can be performed by the end user.

In yet another embodiment, a non-transitory computer-readable medium contains executable code for implementing a medical critical results communication, including: receiving an identification and a classification of a finding of criticality on a patient, from a health care provider sender, and storing the identification and the classification of the finding in a database of a computer system; creating a critical results communication in the database, using a processor of the computer system; transmitting the critical results communication to a recipient by a predetermined electronic mode of communication using the computer system; receiving an acknowledgement from the recipient that the critical results communication was received, and storing the acknowledgement in the database; receiving feedback and/or initiation of clinical intervention and a follow-up action from the recipient, storing the feedback and/or initiation of clinical intervention and the follow-up action in the database; transmitting the feedback and/or initiation of clinical intervention and follow-up action to the health care provider sender in a response from the recipient; receiving diagnostic confirmation from the recipient and/or the healthcare provider sender, regarding the patient, and storing the diagnostic confirmation in the database; performing an analysis of critical results data in the database using the processor, and performing an analysis of compliance with stored established medical standards; and providing the critical results data analysis and the compliance analysis to the at least health care provider sender.

In yet another embodiment, a computer system which implements a critical results communication, includes: at least one memory which contains at least one program which includes the steps of: receiving an identification and a classification of a finding of criticality on a patient, from a health care provider sender, and storing the identification and the classification of the finding in a database of a computer system; creating a critical results communication in the database, using a processor of the computer system; transmitting the critical results communication to a recipient by a predetermined electronic mode of communication using the computer system; receiving an acknowledgement from the recipient that the critical results communication was received, and storing the acknowledgement in the database; receiving feedback and/or initiation of clinical intervention and a follow-up action from the recipient, storing the feedback and/or initiation of clinical intervention and the follow-up action in the database; transmitting the feedback and/or initiation of clinical intervention and follow-up action to the health care provider sender in a response from the recipient; receiving diagnostic confirmation from the recipient and/or the healthcare provider sender, regarding the patient, and storing the diagnostic confirmation in the database; performing an analysis of critical results data in the database using the processor, and performing an analysis of compliance with stored established medical standards; and providing the critical results data analysis and the compliance analysis to the at least health care provider sender; and at least one processor for executing the program.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic diagram of a system which implements a critical results communication in a medical field, according to one embodiment consistent with the present invention.

FIG. 2 is a flowchart showing steps in implementing a critical results communication, in one embodiment consistent with the present invention.

### DESCRIPTION OF THE INVENTION

The present invention relates to a system and method of automating and customizing a standardized data recording, tracking, and analysis in a critical results medical communication.

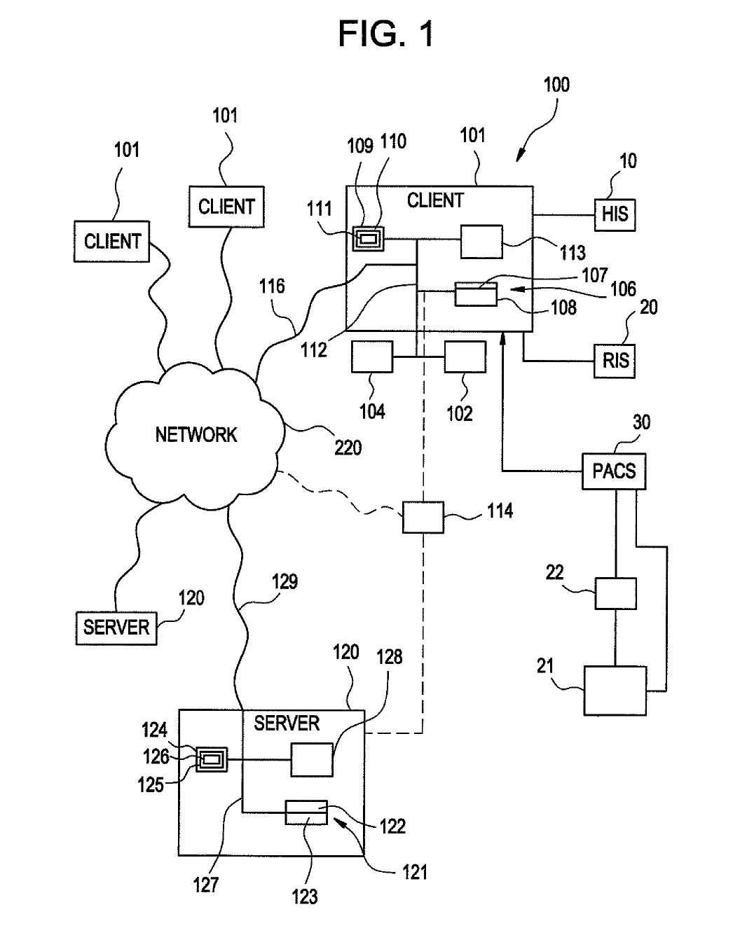

According to one embodiment of the invention illustrated in FIG. 1, medical (radiological) applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, and/or other systems. The system 100 may be designed to conform with relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, radiographic device 21, CR/DR plate reader 22, and PACS 30, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104.

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes, as described in U.S. Pat. No. 8,081,165 issued Dec. 20, 2011, the entire contents of which are hereby incorporated by reference. The multi-functional programmable stylus may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101.

According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution eyewear may be used as a graphical display to provide end users with the ability to review images. According to another embodiment of the invention, the high resolution eyewear may provide graphical display without imposing physical constraints of an external computer.

According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations.

According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a Local Area Network (LAN), Wide Area Network (WAN), and/or other networks. The data storage device 113 may be an internal storage device. According to one embodiment of the invention, system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a LAN, WAN, and/or the Internet, over a communication link 116, 129. Further, even though the systems corresponding to the HIS 10, the RIS 20, the radiographic device 21, the CR/DR reader 22, and the PACS 30 (if separate) are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

The present invention relates to a system and method of automating and customizing a standardized data recording, tracking, and analysis in a critical results medical communication.

A. Creating a Critical Results Communication Schema

In conventional practice, the process of critical results communication (CRC) largely includes a two-step process, where one party (i.e., CRC sender) conveys critical results data to a second party (i.e., CRC recipient), who subsequently initiates a responsive clinical action. This communication largely takes place through either verbal or written communication and involves non-standardized textual data. The communication responsibilities are frequently outsourced to non-physician third parties, which has the potential to introduce error and misunderstanding to the CRC.

In the present invention, the CRC process includes a series of computer-implemented predictable and sequential steps aimed at ensuring that the communication and understanding of the critical result is accurate, complete, understood in its entirety, acted upon in a timely fashion, and compliant with institutional, community and societal standards for best clinical practice.

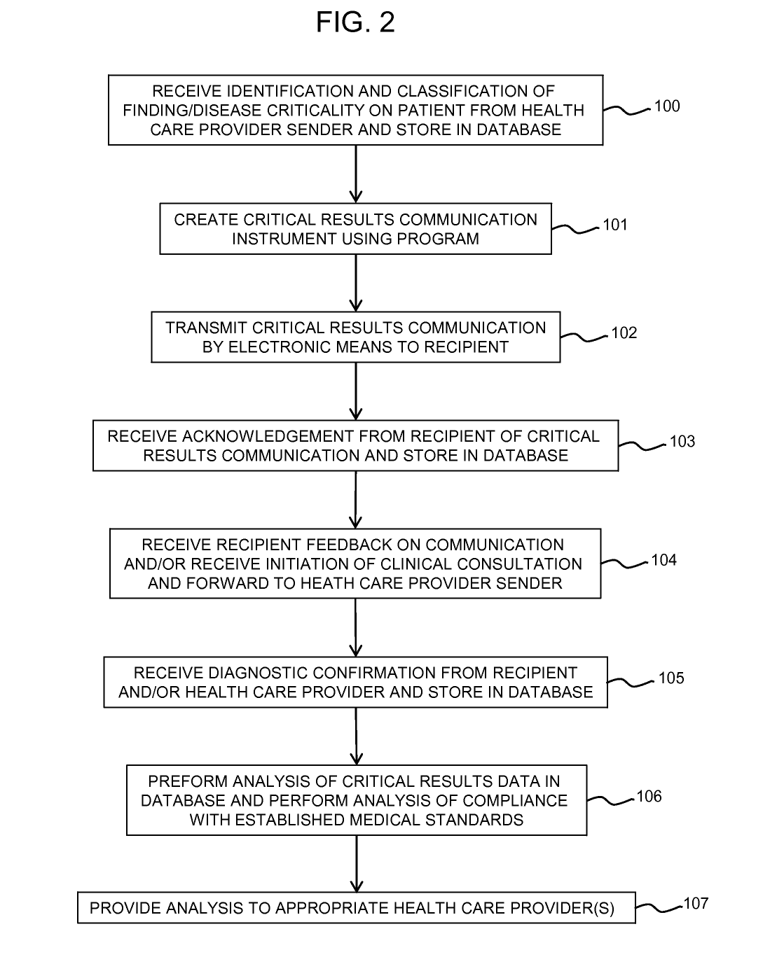

In the present invention, the program 110 (i.e., as carried out by the processor 106) performs a number of sequential steps in the optimized CRC schema, as provided below and as shown in FIG. 2, by beginning with identification and classification of the finding/disease which fulfills criteria for a “critical result”, to issue an alert to a CRC recipient.

Steps in the Critical Results Communication (CRC) Schema:

Step 100: The program 110 receives identification and classification of the finding/disease criticality on a patient, from a clinician or other health care provider, and stores in the database 113 (see FIG. 2)

Step 101: The program 110 (automatically) creates a critical results communication instrument, which is sent to the CRC recipient by the predetermined electronic means (i.e., a mode of communication including text message, facsimile, email, etc.).

Step 102: The program 110 (automatically) transmits the critical results communication (i.e., text message, email, etc.).

Step 103: The CRC recipient receives and acknowledges the critical results communication, and the program 110 receives the CRC recipient's acknowledgement and stores same in the database 113.

The CRC recipient optionally provides feedback of understanding of the critical results communication, and optionally can arrange for additional consultation with other health care providers regarding the patient, and inputs this feedback and/or request for additional consultation into the computer database 113, where the program 110 saves it and then forwards it to the CRC sender.

Step 104: Thus, the program 110 receives the CRC recipient's feedback and/or initiation of clinical intervention and follow-up actions, stores in the database 113, and forwards it to the appropriate party/parties (i.e., the health care provider).

Step 105: The program 110 then receives diagnostic confirmation from the CRC recipient and/or other healthcare provider, regarding the patient, and stores it in the database 113.

Step 106: The program 110 (automatically) performs an analysis of critical results data in the database 113, and performs an analysis of compliance with established medical standards.

Step 107: The program 110 provides the analyses to the appropriate healthcare provider(s).

The identification of critical results in Step 100 can be manual or automated, in accordance with established practice guidelines and available technologies. In manual critical results identification, the radiologist interpreting the imaging dataset would identify a finding or disease of sufficient criticality based upon established or personal standards. Thus, Step 100 would be the receipt of such a manual input by the program 110.

In automated critical results identification, the program 110 would invoke a supporting technology such as natural language processing, or utilize a form of artificial intelligence (e.g., neural network), to identify a finding or indication in the radiology report or order entry data that would be saved in the database by the program 110 in Step 100, and then used by the program 110 to automatically trigger a CRC in Step 101.

Once the CRC application has been activated in Step 101, the CRC critical instrument or schema is a creation by the program 110 of the critical results communication data. While conventional practice typically utilizes unstructured (i.e., non-standardized) data for CRC, a preferred method would be utilization of standardized data, which could in turn allow for the creation of a referenceable CRC database 113. Incorporation of imaging data by the program 110, directly into the CRC, is a more efficient and understandable means of communicating critical results findings in radiology practice, as opposed to use of text-based communication alone. At the same time, the manner in which data is presented by the program 110 can be customized in accordance with the specific preferences of the CRC recipient, with the goal of improving end-user acceptance and understanding. This customized data presentation can be automatically performed by the program 110 and tied to each individual end-user's authentication and identification.

In addition to data presentation, customization of the CRC can also be applied to the transmission process, where individual recipient end users can have preferred methods of how data is transmitted by the program 110 (which can in part be modified in accordance with the urgency of the CRC). Options for data transmission in Step 101 can include (but are not limited to) telephone, e-mail, instant messaging, facsimile, texting, or face to face interaction. The single most important factor is that the CRC is transmitted by the program 110 and received by the CRC recipient in a timely fashion, commensurate with the urgency and criticality of the critical result. When communication is performed electronically (using the program 110), time stamps can be automatically recorded by the program 110, which document the day/time of CRC transmission, the criticality and urgency of the critical result, the methods used in data transmission and the identities of the sender and intended recipients.

Data is also automatically recorded by the program 110 into the database 113 during the next step of the CRC schema which consists of receipt and acknowledgment of the CRC (i.e., Step 103). Step 103 is important in documenting that the critical results data have in fact been received by the intended recipient and appropriate clinical actions can be performed to address the critical result. An important component of this step is the ability of the program 110 to unequivocally document the identity of the recipient of the CRC, which is often lacking in conventional systems, and can be a subject of debate in conventional practice. By the program 110 directly integrating authentication/identification technologies such as biometrics into the CRC schema and technology in use, one can determine and document the identity of the recipient, without any potential for future denial. In the event that an intended recipient does not acknowledge receipt of the CRC in a predetermined time period, an escalation communication pathway (i.e., more urgent and more frequent communication transmissions, forwarding the transmission to other parties, etc.) can be automatically activated by the program 110, which follows pre-defined rules in accordance with the urgency of the CRC, institutional guidelines, and societal (i.e., best practice) standards. By the program 110 electronically documenting and time stamping all communication actions, a reliable and unimpeachable record is available for review and analysis, with the goal of continuously improving operational efficiency and clinical outcomes.

While receipt acknowledgement is a fundamental requirement of CRC, it does not conclusively ensure that the data communicated was completely understood on the part of the recipient, and this misunderstanding (or incomplete understanding) can potentially serve as a source of medical error. While conventional CRC efforts have attempted to remedy this potential source of error by having the recipient “read back” the message conveyed, this verbal reiteration does not always ensure cognitive understanding. One solution to more effectively address this potential disparity between acknowledgment and understanding is the program's 110 inclusion of standardized data in the CRC which incorporates clinical and time urgency of the critical results, follow-up recommendations, the recipient's clinical feedback, and option for additional consultation (i.e., Step 104) to/from the recipient. All of these data can be standardized and incorporated by the program 110 into the CRC database 113, thereby providing a valuable tool for longitudinal analysis.

Once the CRC data has been successfully transmitted, received, and understood, clinical action is initiated. In conventional practice, the relative lack of data integration between the reporting system, PACS 30, and electronic medical record (EMR), preclude the recipient physician from performing these clinical actions inside the same application as used in the CRC process. If for example, a radiologist identifies a questionable pulmonary embolus in the lung base of an abdominal CT exam, he/she may recommend a follow-up chest CT angiography exam for definitive diagnosis. If the CRC issued by the program 110 incorporated the annotated “key images” from the abdominal CT exam along with corresponding text data, the recipient physician would be able to directly visualize the critical result of concern, evaluate the radiologist-generated diagnosis and recommendations, and independently determine the best course of clinical action. In conventional practice, if the recipient physician agreed that the recommendation for chest CT angiography was warranted, he/she would have to log out of the CRC application and log into a separate radiology ordering computer application in order to place the emergent order for chest CT angiography. The ordering physician may or may not receive an exact scheduling time upon ordering and would in all likelihood have wait until either notified by the interpreting radiologist (or a designated subordinate), or receiving the final report. Since this conventional workflow introduces additional time delays, workflow inefficiencies, and potential for error, the program 110 integrates these follow-up actions directly into the CRC schema and technology in use. The program 110 would perform this function by creating a direct link between the CRC follow-up recommendations and resulting physician orders.

In one example, the CRC recipient would have the ability to “agree with” the recommendation for chest CT angiography and “order now”, and input same into the computer, tablet etc. in Step 105. Since the order was generated in accordance with an initial CRC, the program 110 labels this newly ordered imaging study as a “critical results” exam, which automatically triggers a new CRC (i.e., one example of how an automated CRC is generated from order entry data). When the technologist and radiologist retrieve the order entry data, they are presented with the initial CRC data which includes the annotated key images and associated text data, which assists in protocol selection, interpretation, and creation of a new CRC. In the course of creating the new CRC, the previous CRC (from the abdominal CT exam) is automatically “linked” by the program 110 with the current CRC data (from the chest CT angiography exam). In this manner, the data from both CRCs are “linked” to one another by the program 110, and would be reviewable in tandem whenever someone was to open up either of these critical result communications on their image display device 102.

Clinicians would also be provided with the ability to “link” supporting clinical data to the radiology CRC. If for example, this same patient had a prior history of deep venous thrombosis which was documented on a previous discharge summary, the clinician could “link” this data in the CRC using the clinical feedback feature of the program 110, and either “inserts” the entire document or can “cut and paste” specific data from this document into the current CRC. This provides a mechanism for “linking” imaging and clinical data onto a single CRC. (In addition to manual data extraction and linking, this function could also be automatically performed by the program 110 through computerized data mining techniques using artificial intelligence in combination with natural language processing.)

The above example illustrates three important features of the program 110 of the present invention: 1) the ability to integrate clinical orders (tied to follow-up recommendations of the CRC) into the CRC application; 2) the ability to “link” disparate data; and 3) the ability to automatically generate a CRC from order entry data.

The CRC process also includes data confirmation in Step 105 by the program 110, which provides a mechanism to document the diagnostic accuracy of the CRC being reported by the radiologist. This provides critical peer review data from the referring clinician, who often has access to relevant clinical and/or historical data not known by the radiologist at the time of image interpretation. In addition to providing feedback on the diagnostic accuracy of reported CRCs, this would also include feedback on cases in which critical results went unreported. This could include either a “missed” critical result diagnosis or a critical result which was documented in the radiology report, but was not communicated in accordance with established CRC criteria.

Data analysis serves as the final Step 106 of the program 110 in the CRC schema and can be applied to data captured at all individual steps in the CRC schema, as well as the collective CRC process. Since the proposed innovation is predicated upon the use of standardized data (which can consist of imaging, textual, numerical, graphical, and pictorial data), the creation of a referenceable database 113 becomes a reality. The resulting analytics can be used by the program 110 for a myriad of functions including (but not limited to) research, education and training, decision support, creation of best practice (i.e., evidence-based medicine) guidelines, quality assurance, individual and institutional operational performance assessment, and clinical outcomes analysis.

Derived analytics can be customized by the program 110 to the specific needs and preferences of individual and institutional healthcare providers with creation of automated alerts and prompts when pre-defined data thresholds are reached. Suppose for example, a particular clinician was demonstrated to have relatively poorer CRC response times than his/her peers within a given institution. In the course of the program 110 analyzing technology use, the program 110 provides information that the physician in question was not taking full advantage of one of the notification features frequently used by his/her colleagues, which provides automated CRC alerts at 25%, 50%, and 75% time intervals of a pending CRC. By learning of this underutilized feature, the clinician could begin to take advantage of available technology, while also being presented with “before and after” analysis by the program 110, which provides insight as to how CRC performance data changes through a specific intervention. This illustrates that the goal of these CRC analytics is not intended to be punitive, but instead to be educational and empowering, with the goal of improved clinical outcomes based upon objective and customizable data analysis.

B. Creating the Technology

In formulating a technology development plan, the first step in the CRC schema of the present invention is the identification of criticality. The technology created must support both manual and automated modes of operation. Manual mode is straightforward; the end-user (e.g., radiologist) determines a threshold for criticality has been reached and activates the CRC application. In automated mode, a computerized system of analysis (i.e., run by the program 110) determines the threshold of criticality has been reached and the program 110 automatically launches the CRC application. This computerized method of analysis can take a number of forms including (but not limited to) predefined rules or artificial intelligence techniques utilizing natural language processing. An alternative automated trigger for CRC activation carried out by the program 110, can also be imposed by the referring clinician, by requesting CRC status when placing the order for the imaging study. If an automated trigger causes the program 110 to open up the CRC application, the radiologist has the ability to manually override and cancel the CRC application, but in doing so creates an electronic receipt of cancellation, which is saved by the program 110 in the CRC database 113 for subsequent review and analysis.

Once the application has been opened on the image display device 102, by the program 110, the radiologist is tasked by the program 110 with the following input requirements:

1. Identification and annotation of a single or multiple key images.

2. Recording of mandatory supporting data (which is standardized).

3. Option to record additional non-standardized data.

4. Verification and/or editing of CRC recipients.

The selection of key images can be as simple as a single input command (e.g., speech command “save key image”, right click on multi-programmable mouse, or selection of key image icon from user interface (UI) toolbar) to the program 110. Once the key image/s is selected, the radiologist is tasked with annotating the image by marking the specific region of interest, along with the option for additional annotations (e.g., size, attenuation coefficient, morphology, etc.). The mandatory standardized data fields can be accessed by having the program 110 activate the “supporting data” field through a number of input options (e.g., speech command, mouse, icon, etc.). Once activated, the requisite data fields are presented on display 102 for review by the program 110, with or without the supporting options. The mandatory data fields and associated options are listed below.

Mandatory Standardized Data Fields for CRC:

A. Finding or Diagnosis

B. Anatomic Location

C. Classification
1. Emergent
2. Discrepant
3. Unexpected
4. Clinical requests

D. Urgency
1. Hyper-acute (<1 hour)
2. Acute (<6 hours)
3. Sub-acute (<24 hours)
4. Routine (<72 hours)

E. Follow-up Recommendations*
1. Intervention
2. Medical treatment
3. Imaging exam
4. Lab/clinical testing
5. Consultation * Once the follow-up recommendation category has been selected, the end-user has the option for inputting into the database 113 additional descriptive information (e.g., surgical biopsy, chest CT, neurosurgical consultation).

An ontology can be created by the program 110 to support the categories of Finding/Diagnosis and Anatomic Location. In addition, computerized anatomic localization (following annotation of the region of interest), can be performed by the program 110. The creation of finding-specific macros by the program 110 could provide a fast and efficient means for providing these data, along with the ability to incorporate supplemental descriptive data (e.g., size, morphology, contrast enhancement, etc.). The ability to add non-standardized data can be performed in a supplemental data box, which accommodates typed or spoken text. In addition to descriptive supplemental data, another optional data field provided by the program 110 for “linked” data could be activated, in which ancillary data in the patient's imaging or clinical medical folders could be added by implementing a “cut and paste” option. The net result is an annotated image with accompanying standardized data defining the finding/diagnosis, classification category, anatomic location, urgency, and follow-up recommendations.

Before closing the CRC application, the radiologist is presented with a program 110 derived hierarchical list (i.e., rank order) of recipients. If accepted ‘as is”, the program 110 will use this list to transmit the CRC and engage the escalation pathway in accordance with institutional guidelines commensurate with the urgency of the critical finding. Alternatively, the radiologist has the option to modify this recipient list by adding, removing, or adjusting the rank order of recipients. (Note that all modifications are recorded by the program 110 in the CRC database 113.) Once the recipient list has been finalized, the radiologist enters the “Complete” command and the program 110 begins the CRC transmission. All actions are time stamped and recorded in the database 113 by the program 110, along with the identity of the responsible end-user (using biometrics for authentication/identification). In addition to being recorded in the central CRC database 113 by the program 110, the CRC data is also recorded in duplicate in the patient imaging folder by the program 110, for direct access.

The transmission of CRC data by the program 110 is established by defined rules established by the institution, individual clinical care providers, and societal standards, and incorporates an escalation pathway to ensure timely and reproducible CRC receipt. While each clinical care provider can establish his/her individual preferences as to the mode of CRC transmission, institutional and societal standards (based upon best practice guidelines) will dictate CRC receipt, acknowledgement, and follow up action time requirements. The timing of when the escalation pathway is automatically activated by the program 110 can be determined in several ways which include (but are not limited to) societal and/or institutional guidelines, historical records of the clinical care provider in question (provided by analysis of the CRC database), and defined time urgency and classification of the CRC in question.

In addition to automated activation, the escalation pathways can also be manually activated by the primary clinical care provider, in the event they are not available for rapid CRC response. Examples may include the surgeon who is actively engaged in surgery, an ER physician who is taking part of an emergent resuscitation, or primary care physician who has recently signed off clinical responsibilities to his on call colleague. In addition to a “clinical” escalation pathway, which reacts to physician unavailability, a “technology” escalation pathway is also created by the program 110, which monitors the communication system used and notifies technical support staff (e.g., chief information officer) in the event that technical problems arise, such as losing Internet access. In this event, the technical escalation pathway would be triggered by the program 110 which facilitates alternative transmission options which circumvent the technical problem encountered.

The CRC sender has the option to transmit CRC data to more than one recipient at any time. This can be done one of two ways; either selecting from the escalation pathway list on the display 102, or manually inputting the name of the desired recipient into the CRC application. In addition to clinical care providers, CRC data can also be sent by the program 110 to patients and/or their legal guardians. This may have value in non-emergent cases of critical results where follow-up is required to ensure interval stability or improvement. Along the same lines, simultaneous CRC transmission by the program 110 to administrative and/or quality assurance personnel can also be performed, which may be of value in clinical situations where the sender is concerned about timely and/or appropriate follow-up.

Receipt and acknowledgment is perhaps one of the most important steps in the CRC process (i.e., Step 103), for without it timely and effective clinical action (in accordance with the critical imaging results) does not take place. In conventional practice, combined data transmission and receipt is customarily documented as an addendum in the radiology report. This typically consists of 1-2 free text sentences recording the date and time of the communication, the identity of the communicating parties, and the specific finding/s being communicated. While the data can be analyzed using natural language processing (NLP) for longitudinal analysis, most existing information systems and reporting technologies do not support creation of a standardized database which prospectively records, tracks, analyze these data.

One important feature of the present invention is to go further and for the program 110 to utilize the derived real-time data analytics of Step 106 to create customizable interventions, aimed at promoting best practice guidelines and improved clinical outcomes. One such intervention might include real-time modifications to the escalation pathway by the program 110, in accordance with the severity and context of the CRC. An example may include an acute ruptured appendicitis in a child with tachycardia. Based on the heightened emergency and criticality of timely surgical intervention, the program 110 may respond by simultaneous emergent CRCs to the surgeon, anesthesiologist, and operating room nurse administrator on call. This would attempt to speed up clinical triage and mobilization of the operating room staff for improving clinical outcomes in an extremely high risk clinical emergency.

The program 110 serves to standardize the receipt and acknowledgment step (i.e., Step 103) in the cumulative CRC process, while also adding knowledge and understanding. In conventional practice it is not unusual for there to be a cognitive disconnect in the communication process, such that the party receiving the critical results data may not have a complete or accurate understanding of the data and/or clinical ramifications. This important component of “data understanding” is promoted in several features of the program 110 which include the following:
1. Mandatory inclusion of standardized data reporting CRC classification, urgency, and follow-up recommendations.
2. Integration of a standardized system for documenting CRC understanding, such as:
   a. Understanding complete, agree with analysis and recommendations; or
   b. Understanding complete, disagree with analysis and recommendations (provide additional data); or
   c. Understanding complete, consultation requested; or
   d. Understanding incomplete, consultation required.
3. Integration of a multi-directional consultation tool which provides multiple input options (e.g., image annotation, shared cursor, speech, text), with the ability to capture consultation data.

In order to illustrate the standardized options for CRC Data Understanding, a common example is described, of a CT report with the finding of acute (low grade) appendicitis, which has been categorized as emergent (classification), acute (urgency), and requiring surgical intervention (follow-up recommendation). The surgeon receiving the CRC using the program 110, may determine that upon review, he/she fully understands the information provided and is in agreement with the diagnosis and recommendations. As a result, he/she responds with Understanding option 1 (i.e., Understanding complete, agree with analysis and recommendations), and no further action is required by either party.

In the event that the surgeon fully understands the CRC data but disagrees with the diagnosis and/or follow-up recommendations, he/she may select Understanding option 2 (i.e., Understanding complete, disagree with analysis and recommendations (provide additional data)). In this example, the surgeon is aware that the patient has had a previous appendectomy and the diagnosis is therefore incorrect and provides this feedback to the interpreting radiologist. All data associated with the CRC is automatically recorded by the program 110 in the database 113 (providing for longitudinal analysis), including the identity of the parties authoring and receiving data; along with date/time stamps of all actions. In this example, the radiologist reacts to the surgeon's feedback by modifying the radiology report with a new differential diagnosis (e.g., Crohns disease, diverticulitis, typhlitis) and corresponding changes related to classification, urgency, and follow up recommendations. Alternative responses by the surgeon may include option 3 (i.e., Understanding complete, consultation requested) or option 4 (i.e., Understanding incomplete, consultation required). In one case (option 3), the surgeon has complete understanding of the CRC data but requests consultation with the radiologist (e.g., to collectively review the imaging data). In the other case (option 4), the surgeon does not fully understand the CRC data and this by definition requires additional consultation between the two parties. Once this consultation has been completed, the surgeon would in turn convert his/her CRC Data Understanding option from option 4 to either option 1 or 2, in accordance with agreement between the two parties. Since the program 110 would record all responses and communications, the serial change in the surgeon's response would be recorded along with consultation data. This in effect creates a reproducible timeline, recapitulation of the CRC data, and interaction between the communicating parties in the event that a third party wishes to review the sequence of events which transpired in the course of a clinical event (e.g., adverse outcome).

The consultation feature is an integral component of the program 110 and serves as a mechanism to bridge the proverbial gap in knowledge, understanding, and agreement which commonly exists in conventional practice. In the “old days” of analog medical imaging practice, film images mandated that a physician physically travel to the radiology department to review images and in doing so would frequently consult with the radiologist. This created a face-to-face opportunity to educate, share information, and improve understanding, which in many respects has worsened in digital practice. The program 110 is designed to mandate improved communication and understanding while also creating a quantitative and qualitative method for improved accountability. In order to be effective and adopted in everyday practice, the consultation application of the program 100 is designed to be workflow efficient, easy to use, adaptive to the individual needs and preferences of different end users, and intuitive.

Since face-to-face (or even telephone conversations) may often be disruptive to workflow, the consultation tool of the program 110 is designed to be directly integrated into end user workflow, in a manner commensurate with individual preferences and the criticality of the CRC data. If for example, the CRC is categorized as emergent, hyperactive, and requiring immediate intervention, the heightened criticality would mandate immediate consultation which supersedes all elective consultation preferences. In this case, the mandatory and time sensitive consultation would be expedited as the top workflow priority and the involved CRC parties (i.e., sender and recipient) would be required by the program 110 to complete the consultation before any other computer-based actions can be performed.

If on the other hand the consultation is categorized as unexpected, sub-acute, and requiring follow-up imaging; the consultation would be required to be completed by the program 110 within a designated time frame (e.g., 12 hours), but existing workflow is not forcibly interrupted by the program 110. The CRC parties can be presented with a list of consultation options by the program 110 at the time of CRC receipt acknowledgment (i.e., Step 103), and the combined input will in turn serve as the driver for the timing and method of consultation. As an example, if the two parties agree on a specific time for the consultation to take place (which can be performed electronically by selecting the consultation scheduling feature of the program 110), the CRC consultation tool of the program 110 will automatically notify the parties of the scheduled consultation at pre-determined time intervals (e.g., 15 minutes, and then 5 minutes prior to the scheduled time) with the options to continue as planned or reschedule. In the event the reschedule option is selected by a party, the identity of the party requesting rescheduling will be recorded by the program 110 along with the time of the rescheduled consultation. (This provides a data driven analysis of determining consultation reliability and compliance.) Once both parties are in agreement, the consultation program 110 application is engaged and the CRC data is simultaneously presented to both parties by the program 110 along with a synched cursor and toolbar which allows for both parties to navigate the imaging data in tandem and review data inputs from either party. When speech is used in the consultation, the voice files are recorded and incorporated into the CRC Consultation database 113 by the program 110. The consultation cannot be completed until both parties agree and an “Understanding is complete” action has been recorded by the program 110. This ensures that no party can subsequently claim there was a data misunderstanding or failed CRC communication.

Once CRC receipt and understanding has been documented by the program 110 in Step 103, the next step in the CRC process is clinical action, which is tied to the CRC follow-up recommendations. This can take a number of different forms including (but not limited to) orders for a clinician consultation, laboratory or clinical test, pharmaceutical, imaging study, or clinical action (e.g., remove feeding tube). The common feature for any of these actions is the physician order, which takes place in information system technologies (e.g., most often in the electronic medical record (EMR), but potentially in other information systems such as the laboratory information system, radiology information system (RIS), pharmacy information system, etc.). The recommendations can be associated by the program 110 with a template that contains a pre-determined set of actions related to each recommendation. Alternatively, the CRC program 110 can present a list of actions that can be manually selected. A combination of these would represent a standard template that could be edited by individual physicians who were initiating the CRC.

The next step is to translate the pre-defined protocol/template or edited template or newly generated list for follow up, and for the program 110 to automatically initiate the appropriate orders after recording the orders that were generated in the CRC database 113. Given an integration with an electronic medical record (EMR) or other order entry system, these orders could be automatically generated by the program 110 with final electronic sign-off by the person initiating the CRC to ensure the orders were placed correctly required in most cases.

Alternatively, the CRC program 110 could generate a script or macro that would electronically sign into one or more order entry systems with the user's credentials and place each order, pausing for electronic signature. These orders could be generated by the program 110 at the level of the user's portal or could potentially more directly interface with the computer system using HL7 or using a service oriented architecture (SOA) or another communication protocol. Once the computer system has been engaged, the corresponding order is automatically generated by the program 110 based upon the recorded (and agreed) upon CRC data, along with the patient's identification and clinical data (e.g., chest CT angiography to evaluate for pulmonary embolus). The entire automated ordering process could be triggered by the program 110 having the end user simply activate the “Order Now” feature of the CRC application, which would in turn present the end user with the computer-generated order for modification and/or completion of one or more orders. The selection function of the program 110 could in turn have biometrics integration for authentication and identification of the end-user placing the order in lieu of a signature, which could either be directly recognized by the order entry system or alternatively, the biometric device could be used to identify the ordering physician which would then automatically generate what appears to the order entry system as a digital signature. All of these steps would be automatically recorded in the CRC database 113 by the program 110. This ordering function can at any time be converted from automated to manual operation, thereby allowing the end user to manually input the order in a more interactive and customary fashion such as the way in which orders are generally created by the order entry system(s). In some cases automated ordering would allow additional end user input for order clarification when multiple options exist and cannot be readily determined by computer-driven artificial intelligence and predictive analytics. An example would include the appendicitis-driven follow-up recommendation for surgical consultation. A number of different options may be presented by the program 110 for determination of a surgeon to select for a consultation, for example, and include (but not limited to) the following:
1. Manual input of name of surgeon for consultation.
2. Computer-derived names of surgeons (in rank order) based upon historical usage of the ordering end user, clinical context, and surgeon availability.
3. Computer selection of “on call” surgeon.
4. Computer-derived name of surgeons (in rank order) based upon CRC performance analytics (e.g., responsiveness, timeliness, and/or clinical outcomes).

Once the resulting clinical action has taken place, it remains undetermined as to whether the reported critical result was indeed accurate. This necessitates an additional step in the collective CRC process, which is classified as Diagnostic Confirmation. In this step, the clinician/s acting upon the CRC will ultimately have the ability to confirm diagnostic accuracy based upon a number of potential data sources including (but not limited to) response to clinical treatment, surgical intervention, pathology results, medical surveillance and monitoring, and follow-up clinical and/or imaging data. This effectively serves as the final data point to measure clinical outcomes and aid in the creation and refinement of “best practice” guidelines and standards. The data recorded in the database 113 in this step of the CRC process by the program 110 would include the identity of the clinical care provider establishing diagnosis, the validity of the original CRC diagnosis, data sources used in diagnostic assessment, the date and time diagnosis is established, and ensuing clinical outcomes (i.e., response to treatment/intervention). Since the latter data will largely be determined through analysis of unstructured data (e.g., hospital discharge summary, progress note) by the program 110, this will require additional technology such as NLP for data extraction and categorization.

The core data component of this Diagnostic Confirmation step is found below, which provides four (4) standardized options provided by the program 110, for the clinician to select from, which provides clinical feedback as to whether the CRC radiologic diagnosis was confirmed clinically.

Standardized Method for Assessment of CRC Diagnosis and Communication:
1. Agree with initial diagnosis, without qualifications
2. Agree with initial diagnosis, with qualifications*
3. Disagree with initial diagnosis*
4. Uncertain Diagnosis*
5. Failure to communicate critical result
   a. Missed critical finding
   b. Failure to communicate critical report data *Additional data required; which can include unstructured free text and/or supplemental report data from the EMR.

These options include Agreement, Disagreement, or Uncertainty and can be supported by supplemental data contained in the patient electronic medical record (EMR), which can be attached to the CRC program 110 in a manner similar to e-mail attachments. When the “supplemental data” option of the program 110 is engaged by the clinician at the time of Diagnostic Confirmation assessment, the end user is provided with the ability to select options from a pick list which is created in direct context to the reported CRC finding/diagnosis using computer artificial intelligence (e.g., neural networks); predictive analytics based upon historical use; or predefined rules. Alternatively, the end user can directly input the supplemental data source of interest through speech or written text into the computer, and the program 110 will retrieve the corresponding data field for manual selection. Data analytics derived from this step provide valuable clinical diagnostic accuracy feedback to the reporting radiologist which is largely lacking in conventional practice and serves as a potential source of repetitive error.

While not directly applicable to prospective CRCs, a fifth data point is captured in this database 113 by the program 110 which refers to radiology report data which should have generated a CRC but did not. This could include either a “missed” critical finding or one that was included in the report but did not trigger an expected CRC by the program 110. The method for reporting these “missed CRCs” could include a report application (i.e., missed CRC) which allows for the end user to provide direct feedback to the CRC database 113 in either case. Due to the fact that this has important clinical implications, the recording of a “missed CRC” by the program 110 would automatically have the program 110 trigger an alert to the reporting radiologist, radiology department chief, and/or medical chief of staff. A mandated review would be required to validate or invalidate the reported missed CRC, and if indeed found to be accurate, require immediate clinical action.

The final step in the CRC process is data analysis (see below) (i.e., Step 107), which is a direct product of the standardized CRC database 113 created by the program 110.

Components of CRC Data Analysis:

A. Metrics
1. Accountability
2. Timeliness
3. Accuracy
4. Compliance
5. Follow-up
6. Clinical Management

B. Players
1. Radiologist
2. Clinician (primary and consulting)
3. Administrator
4. Nurse
5. Patient
6. Technologist

The primary metrics include Accountability (i.e., responsiveness), Timeliness, Accuracy, Compliance (with established standards, guidelines, and institutional policies), Follow-up, and Clinical Management. These metrics can be analyzed on individual, departmental, and institutional levels by the program 110, and used to determine relative strengths and deficiencies within the CRC process, along with opportunities for improvement. When deficiencies are identified by the program 110, and interventional strategies are employed by the program 110, the dynamic nature of the database 113 provides a mechanism with which objective real-time data can be used by the program 110 for temporal trending and rapid determination as to whether the interventional strategy employed has resulted in the desired outcome and improvement. Due to the fact that the collective CRC process includes multiple steps and players, the database 113 and derived analytics provide a mechanism for the program 110 to account for confounding variables and interaction effects. This provides an objective tool in which individual data outliers can be identified by the program 110, and parsed from the other data variables, so as not to draw negative conclusions on the entire CRC process. An example might include the operating room in a hospital which is slow in mobilizing and responding to acute surgical emergencies. If the surgeon responds to the CRC information promptly and accurately, it would be unfair to penalize the individual for the deficiencies of the operating room administrative and support staff.

Another frequently encountered example is that of institutional deficiencies related to “after hours” staff and technology availability. In the examples of a head CT with questionable stroke or spine CT with questionable spinal cord compression, the follow-up recommendation often includes an MRI, which may not be readily available until several hours later. This forces the referring clinician to either wait until local resources are available or transfer the patient to another facility, which causes additional time delays and cost, along with fragmentation of care. The ability of the program 110 to record and analyze institution-specific data within the CRC database 113 and comparatively analyze relative to national norms (within the respective peer group), provides a valuable tool for resource allocation, technology procurement, and refinement of practice standards and guidelines.

C. Critical Results Data Tracker and Timeline

Up to this point in time, the program 110 has been described regarding the primary communication which takes place upon identification by the program 110 of a “critical result”. In most practice settings, once this communication has been completed and the recipient acknowledges receipt of the critical result, then the process and associated data tracking by the program 110 is concluded. In reality, however, this “primary communication” step is often followed by a series of events and actions, which are all related to the critical result and ultimately contribute to clinical outcomes. As an example, in the emergent finding of intracranial hemorrhage diagnosed on a head CT, the primary communication (i.e., between the interpreting radiologist and the referring clinician) is often followed by a subspecialty consultation (e.g., neurosurgery), which can in turn lead to a surgical procedure (e.g., surgical evacuation of intracranial hemorrhage), followed by a post-operative recovery course, which can also have associated critical events (e.g., recurrent/increased hemorrhage, placement of intra-ventricular catheter for new hydrocephalous). The sum total of these primary, secondary, and tertiary events will ultimately determine clinical outcome; thereby illustrating the importance of both critical results communication and subsequent (i.e., downstream) actions. As a result, definitive critical results data analysis requires creation of a methodology—such as the program 110—which can record, track, and analyze multiple steps, players, and data elements, beginning with identification of a critical result and proceeding on until definitive treatment has concluded.

While the goal of this longitudinal critical results data tracking by the program 110 is the creation of objective and standardized data (for data mining), there are occasions where data associated with a specific event may only be available in a non-standardized format. In the previous example of the intracranial hemorrhage detected on head CT which resulted in a neurosurgical consultation, the associated neurosurgical report will include a non-standardized (i.e., narrative free text) data. While this consultation report will not readily lend itself to traditional data mining, it would nonetheless be made available by the program 110 when reviewing the sequence of events within a critical results continuum. This illustrates an important feature of the invention; namely the ability of the program 110 to link chronologically disparate data which are directly or indirectly tied to the original critical result. This in effect creates a data-driven timeline for each critical result, which defines all involved parties (i.e., players), time stamped events, technologies, and data, which collectively define the resulting clinical outcome.

In addition to medical imaging critical results, any medical critical result (e.g., laboratory data, clinical test data, physical exam finding) can have an associated critical results data tracker and timeline. As an example, if a diabetic patient's glucose or blood pressure measurement is critically elevated, a critical results communication and tracking system would be automatically implemented by the program 110. All subsequent clinical orders, actions, tests, and data would become automatically recorded by the program 110 in the data tracker, recording the involved parties, time stamped interventions, and follow-up data. Once the critical result has been successfully treated (e.g., abnormal glucose or blood pressure measurement returns to patient baseline), or the patient's clinical condition stabilizes, the critical result pathway will be concluded by the program 110. The data contained within this tracking tool of the program 110 can be multidisciplinary in nature including (but not limited to) imagery, textual, graphical, and numerical data.

An example of a chronologic critical results pathway is listed below; with the example of a patient who is discovered to have a suspicious lung nodule on chest radiography.

Time 0 (Identification of critical result):
1. Data: lung nodule
   a. Diagnosis: Lung nodule, suspicious for cancer
   b. Clinical Significance: High
   c. Follow-up recommendations: Chest CT
2. Data source: Chest radiograph (includes data and time exam completed)
3. Involved Parties:
   a. Data identifier: Radiologist
   b. Data recipient: Referring Clinician
4. Data documentation: Chest radiograph report (includes date and time report is completed, sent, received, and reviewed (along with identity of reviewing person))
5. Communication documentation: Electronic transmission and receipt of annotated images (includes date and time communication is sent, received, and confirmed with understanding) (along with identity of person confirming receipt and understanding).

Time 1: Chest CT
1. Data: Lung nodule
   a. Diagnosis: Cancer
   b. Clinical significance: High
   c. Follow-up recommendations: Biopsy
2. Data Source: Chest CT
3. Involved Parties: Radiologist and Referring Clinician
4. Data documentation: Chest CT report
5. Communication: Electronic transmission of annotated images with consultation

Time 2: Pulmonary Consultation
1. Data: Lung nodule
2. Data Sources: Chest radiograph, Chest CT, Patient EMR
3. Involved Parties: Pulmonologist
4. Data Documentation: Pulmonary Consultation Report
5. Communication: Routine transmission of report with receipt confirmation

Time 3: Bronchoscopy and Biopsy
1. Data: Lung nodule
2. Data Sources: Bronchoscopy
3. Involved Parties: Pulmonologist
4. Data Documentation: Bronchoscopy Report
5. Communication: Routine transmission of report and photographic images with receipt confirmation

Time 4: Pathology Report
1. Data: Lung cancer
2. Data Sources: Bronchoscopic Biopsy
3. Involved Parties: Pulmonologist and Pathologist
4. Data Documentation: Pathology Report
5. Communication: Electronic transmission of annotated pathology images

Time 5: Thoracic Surgery Consultation
1. Data: Lung cancer
2. Data Sources: Pathology Report, Chest CT, Patient EMR
3. Involved Parties: Thoracic Surgeon and Pulmonologist
4. Data Documentation: Surgical Consultation Report
5. Communication: Routine transmission of report

Time 6: Surgery (Tumor resection)
1. Data: Lung cancer
2. Data Sources: Intraoperative Evaluation
3. Involved Parties: Thoracic Surgeon
4. Data Documentation: Surgical Report
5. Communication: Routine transmission of report and intraoperative photos

Time 7: Pathology Report
1. Data: Lung cancer
2. Data Sources: Intraoperative Tumor Resection
3. Involved Parties: Thoracic Surgeon and Pathologist
4. Data Documentation: Pathology Report
5. Communication: Electronic transmission of annotated pathology images

Time 8: Chest CT (Baseline Postoperative CT)*
1. Data: Lung cancer
2. Data Source: Chest CT (baseline)
3. Involved Parties: Radiologist and Referring Clinician
4. Data documentation: Chest CT report
5. Communication: Electronic transmission of annotated images *If the surgery has been definitive and no signs of recurrent disease are identified on the post-surgical chest CT, then the critical results pathway is concluded by the program 110 at this time. If however, the tumor persists and additional treatment is required (e.g., chemotherapy, additional surgery, radiation therapy), then the timeline and recorded actions continue on until treatment is terminated (through cure, remission, or death).

While the critical results data tracker and timeline of the program 110 is still “active” (i.e., ongoing), an authorized end-user can access the individual and sequence of events by simply accessing any of the recorded dates, which are analogous to a series of individual nodes on a network. When one of these events (i.e., nodes) is accessed, the end-user will be provided by the program 110 with a capsulized overview of related events in the overall critical results schema (i.e., network), which have been recorded to date. While this capsulized schema can be presented in a number of ways by the program 110, one method would be to display a chronologic timeline with thumb nail images showing the longitudinal sequence of events in a graphical format. When any of these individual events is activated (i.e., computer application is opened for review), the corresponding data for that event (e.g., player names, date/time, data recorded, follow-up recommendations) are displayed by the program 110 on the display 102. These display presentation templates can be customized by the program 110 in accordance with the individual preferences of each individual end-user, who also have the option to incorporate their own data input (e.g., notes, personal observations, reminders), which can be recorded by the program 110 in the database 113 with the option to save and present this data to only to themselves or predefined end-users.

In many circumstances, the end-user may want to have future (i.e., downstream) related data automatically forwarded by the program 110 to them upon receipt in the critical results database 113. As an example, if a patient is undergoing a biopsy for a suspected malignancy, the primary or consulting physician may wish to request that the pathology results are automatically sent by the program 110 to his critical results follow-up queue once they are recorded by the program 110 in the database 113. When the pathology data is recorded by the program 110 in the database 113, an automated alert can be sent by the program 110 to the physician notifying them of newly received “requested” data. Based upon the predefined criticality and time urgency of this data, a priority status can be assigned by the program 110 to the data and incorporated into the automated alert. When the physician reviews the data, an acknowledgement of receipt by the program 110 is recorded in the database 113 and becomes part of the longitudinal data record of the critical results data tracker and timeline. This provides important functionality of the critical results communication pathway, in that data receipt acknowledgement and understanding can be recorded by the program 110 not only for the primary event (i.e., original critical result), but also for later (i.e., downstream) events.

This ability of the program 110 to longitudinally review the entire sequence of time stamped events and participating players provides a unique and comprehensive tool for clinical outcomes analysis. In current medical practice, when an adverse event takes place resulting in significant morbidity or mortality, it is classified as a “sentinel event”; and is required to undergo formal analysis to determine cause and identify systematic and specific deficiencies, with the goal of targeted intervention, process improvement, and elimination of future recurrence. In the conventional model, this sentinel event analysis is manual, time intensive, and often inconclusive due to absence of or conflicting data. It is commonplace for the involved parties to have different recollections of event timing, actions taken, communication, and responsibilities. The absence of a standardized, time stamped, referenceable database often precludes definitive analysis and accountability. The present invention addresses these existing deficiencies through the unequivocal and mandatory recording by the program 110 of standardized data, the identities of involved parties, the time of each action, and the data accessed.

Obviously one would rather proactively intervene at the time an error or oversight takes place rather than wait and create a sentinel event. Having the ability to automate data delivery and an escalation pathway at all steps in the critical results cycle creates a system of enhanced accountability and improved outcomes. To illustrate the enhanced clinical effectiveness of this functionality during secondary events in the critical results communication cycle, an example is a patient presenting to an emergency room for severe headaches. On the initial head CT exam, intracranial subarachnoid hemorrhage is identified, which triggers a critical results communication by the program 110. In the head CT report and critical results communication, brain MR angiography is recommended to evaluate the source of the hemorrhage, with the primary concern of a ruptured aneurysm. In current practice, once the primary critical results communication has been completed, the process has been completed. In the present invention, however, the program 110 has the ability to incorporate subsequent secondary and tertiary events into the critical results schema (i.e., data tracker and timeline), which may in effect create a series of multiple critical results communications.

In conventional practice, the brain MR angiography is performed, a report issued, and clinical action/management is taken upon receipt of the report findings. Since the original critical results event has been completed, the method and timing of communication regarding the MR report findings is highly variable. In an ideal scenario, the interpreting radiologist may directly call the referring physician at the time of interpretation. Alternatively, the interpreting radiologist may issue the report, which is subsequently reviewed by the clinician a day or two later. Rarely, the report may get “lost” through either incorrect patient identification or failure on the part of the referring clinician to review the report. In either case, there is frequently some time delay between the performance of the MR exam and the receipt of report findings by the referring clinician. In the event that the subarachnoid brain hemorrhage was found to be on the basis of an intracerebral aneurysm, short delays in communication could have catastrophic effect due to vasospasm or rebleeding. By creating a methodology to ensure immediate receipt and understanding of report findings (of a secondary event in the critical results cycle), the program 110 of the present invention provides a mechanism for theoretically improving clinical outcomes, while simultaneously communicating to multiple involved parties. In conventional practice, the MR report findings are communicated to the referring clinician (e.g., ER attending physician), who is then tasked with relaying this information on to the consulting neurosurgeon (thereby introducing additional time delays and/or communication errors). In the present invention, the critical results communication can be automatically directed by the program 110 to multiple defined stakeholders simultaneously, which has the benefit of improved timeliness and ensuring receipt/understanding to all principle participants.

By the program 110 having the ability to record standardized data in a referenceable critical results database 113 and correlate this with context-specific clinical outcomes, one can begin to create data-driven and context-specific “best practice” guidelines, which is at the core of Evidence-Based Medicine (EBM). These context-specific EBM guidelines can identify the specific chain of events, actions required, timing, and stakeholder involvement which collectively lead to optimize clinical outcomes. At the time a critical result is recognized, these data-derived EBM guidelines can be presented by the program 110 to the attending physician, for the purpose of guiding the most timely and clinically efficacious clinical diagnosis and management strategy.

An additional option for incorporation into this EBM “best practice” analysis is stakeholder and institutional-specific performance data (Quality Scorecards) included by the program 110. This provides the attending physician with supporting data to guide consultations and referrals, when multiple options are available within a defined time frame. Using the prior example of the subarachnoid brain hemorrhage due to an aneurysm, if the ER physician does not have neurosurgical coverage at his hospital, he will be required to transfer the patient to a tertiary care facility for neurosurgical evaluation. In the event there are 3 different facilities within geographic proximity, the ER physician may use institutional and neurosurgeon-specific performance data provided by the program 110, to guide his decision as to the optimal patient transfer to achieve the best clinical outcome for the given diagnosis.

In conventional practice, quality assurance related to patient care is often done through time intensive and manual chart review by specially trained personnel, which can often be subjective in nature. By using these data-driven context specific EBM guidelines, the program 110 effectively creates an automated and objective method for prospectively analyzing critical results care delivery on a large scale level, with creation of computerized prompts and alerts when these best practice guidelines are not maintained. This creates an ability to intervene at the point of care, when practice alterations can produce the greatest clinical gains. The use of these data-driven EBM guidelines by the program 110, with automated feedback, also creates a unique educational tool which can be customized to the specific needs, abilities, and performance records of individual end-users.

An additional utility of the critical results data tracker and timeline of the program 110, is the ability to create an objective economic model for tying economic reimbursement to observed practice patterns, clinical outcomes, and established EBM guidelines. This creates increased incentive on the parts of individual and institutional service providers to maximize both the quality and timeliness of care delivery. The derived critical results databases 113 and EBM guidelines provide an abundance of computer-driven decision support applications. In the prior example of subarachnoid hemorrhage detected on head CT, the program 110 can provide the interpreting radiologist with statistical analyses of follow-up recommendations, underlying etiologies, and clinical outcomes (which can be further stratified in accordance with patient age, location of the hemorrhage, and its severity). In the event that the radiologist incorporates a follow-up recommendation which is contrary to the EBM guideline standards (which can be identified through natural language processing or neural networks), an automated prompt by the program 110 may notify the radiologist of the discrepancy, and present him/her with supporting data and recommendations from meta-analysis of the critical results communication databases 113.

D. Implementation Strategy

While the CRC program 110 and system attempts to create a comprehensive multi-step solution with the creation of a standardized CRC database 113, the practical solution may begin in a more finite and targeted approach. Any one of the individual steps in the CRC process could be used for targeted innovation, which could provide an opportunity for incremental quality improvement. As an example, a PACS 30 vendor may create an application which provides radiologists with a one-step tool for saving key images, along with a standardized annotation schema for marking up these key images for integration into the radiology report. An EMR vendor may provide an electronic tracking tool which allows end users to document transmission and receipt of critical results communications, which in turn is automatically downloaded into a CRC database 113. A radiology information system vendor may integrate biometrics so as to unequivocally authenticate and identify each individual end user at the time critical results data is accessed and record the data being reviewed. Thus, in addition to creating an “all inclusive” solution, an incremental approach of creating individual components can be instituted, which can in turn drive development of additional synergistic applications, and which can eventually be coalesced into a single comprehensive solution.

The important innovation drivers are timing, economics, and burgeoning mandates. As greater emphasis is placed on data-driven quality and safety in medical practice as a service differentiator, economic incentives will promote innovative technologies which can objectively document improvements in timeliness, cost efficiency, and clinical outcomes. Critical results provide a unique opportunity to dramatically impact healthcare outcomes, due to the urgency and magnitude of the stakes at hand.

### Representative Examples

A few representative examples of sequential workflow are provided below, but the present invention is not limited thereto. The various options and alternatives available for routine operation have been previously discussed above. Two practical examples are provided as routine examples for everyday use.

In the first example, a patient is diagnosed with an acute bowel obstruction requiring emergent surgery. In the second example, the critical results communication database 113 is used by the program 110 for retrospective quality assurance (QA) analysis to identify individual and systematic deficiencies in institutional critical results communication and actions.

A. Identification of Acute Bowel Obstruction on Abdominal CT Imaging
1. Exam is ordered by the referring physician: CT abdomen and pelvis for severe abdominal pain.
2. The patient's historical imaging folder is automatically queried by the program 110 at the time the exam is ordered, to identify pertinent findings on previous medical imaging reports which would be applicable to the anatomic region being currently evaluated along with the clinical context severe abdominal pain. (Note that the computer-generated query and analyses described can be performed using a number of existing artificial intelligence techniques such as neural networks, Bayesian analysis, NLP, etc.)
3. The query identifies a number of prior report findings of interest:
   a. History of partial pancreatectomy due to pancreatitis.
   b. Abdominal aortic aneurysm (4.2 cm)
   c. Urolithiasis (i.e. kidney stones), treated with lithotripsy
   d. Cholecystectomy (i.e. gall bladder removal) due to gallstones
   e. Prostate cancer treated with radiation therapy
   f. Diverticulosis
4. A simultaneous query is generated to retrieve medical history from the patient's electronic medical record (EMR) to identify current medical problems being treated:
a. Type 2 diabetes
b. Coronary artery disease (CAD)
c. Renal insufficiency
d. Arthritis
5. In addition, the EMR data retrieval by the program 110 could provide additional risk factors of relevance, based upon the patient's genetics (i.e., genomic and proteomic data), occupational exposures, social history, diet, medications, and family history.
6. A computer-derived list of potential diagnoses is generated by the program 110 based upon analysis of the historical imaging data (i.e., documented abnormalities), current medical problems, and risk factors.
   a. Abdominal aortic aneurysm (AAA) enlargement, leakage, or rupture
   b. Mesenteric ischemia
   c. Bowel obstruction
   d. Diverticulitis
   e. Pancreatitis
   f. Obstructing urolithiasis
   g. Bladder outlet obstruction
   h. Prostatitis
   i. Prostate metastases
   j. GI Bleeding (related to blood thinner medication for CAD)
7. These computer-derived data and differential diagnoses are attached to the original exam order by the program 110, so that when the exam order data is accessed, this data is available for review.
8. The technologist opens the exam order and accompanying data and selects the imaging protocol which best addresses the clinical indication, prior imaging history, and computer-derived differential diagnoses. (This illustrates how the imaging protocol can be customized by the program 110 in accordance with the automated data queries and analyses.)
9. In this specific example, the differential diagnostic considerations of mesenteric ischemia, GI bleeding, and AAA call for modification of the standard abdominal CT protocol to include pre and post intravenous images, specialized image processing and segmentation of the vascular structures, and multi-planar (2D and 3D) reconstructions.
10. The completed imaging exam is transferred by the program 110 to the PACS 30 for radiologist interpretation.
11. Upon opening the imaging exam and order data, the radiologist is presented by the program 110 with the computer-derived historical imaging data, EMR clinical data, and differential diagnoses (with supporting data).
12. The radiologist reviews the imaging and clinical data, renders interpretation, which is saved in the database 113 by the program 110, for a report.
13. There are several options made available by the program 110 to the radiologist in how interpretation is made, how the report is constructed, and how the computer-generated data is factored into overall analysis.
14. Regardless of the individual radiologist preferences (as relating to how this data is reviewed, interpreted, and reported), a report is sent out by the program 110 which defines the abnormal findings on the current imaging dataset along with diagnoses or differential diagnoses.
15. In this example, the report consists of 3 clinically significant findings:
   a. AAA 4.3 cm
   b. Bowel dilatation suspicious for obstruction
   c. Non-obstructing kidney stone
16. Once the report has been constructed and reviewed by the radiologist, it is ready to be signed and distributed to the referring clinician.
17. Before the radiologist is allowed to “sign off” on the report, computer analysis is performed by the program 110 on the report content, along with cross-reference of the pre-report supporting historical imaging and clinical data of the patient.
18. In the process of performing this computer-based analysis, findings deemed to be of high clinical significance and constituting “critical results” (based upon predefined criteria) are flagged by the program 110 and presented to the radiologist for formal review prior to be allowing to ‘sign off” on the report.
19. A “critical result” alert is sent by the program 110 to the radiologist, and with the program 110, performs the following actions:
   a. Identifies the presence of a potential critical result/s in the report.
   b. Provides supporting data from the patient's historical imaging and EMR data repositories.
   c. Provides critical result-specific decision support data to assist in the diagnosis and report recommendations.
20. In this specific example, the “critical result” of concern is the finding of “bowel dilatation suspicious for obstruction”.
21. Before being allowed to sign off of the report, the radiologist must acknowledge receipt of the critical result notification and formally “accept”, “reject”, or “qualify” it as a critical result.
22. If the critical result is “accepted” by the radiologist, the critical result communication application is automatically launched by the program 110.
23. If the critical result is either “rejected” or “qualified”, the radiologist is required by the program 110 to provide additional data (which will be recorded in the critical results communication database and available for future review) to justify this decision. Note that if a computer-generated critical result is classified as “emergent” (based upon the previous described classification schema) and rejected by the radiologist, the program 110 provides the option for an automated alert to be sent to a third party (e.g. department chief, radiology administrator, referring clinician) for the purpose of quality control and simultaneous review.
24. If the radiologist “accepts” the computer-generated critical result, an automated critical result application will be launched by the program 110, which ensures that the critical result is immediately captured and recorded, the communication pathway is begun, and associated standardized data is recorded in the critical results database 113. (Note that this critical results communication can also be manually activated at any time by the radiologist; by selecting and activating the critical result application from the reporting toolbar or list of icons).
25. Once the critical result application is launched by the program 110, the standardized critical results data input requirements are presented by the program 110 to the radiologist, to ensure that all supporting requisite data is captured and recorded in the critical results database 113 (which is important for future analytics and data mining).
26. The radiologist provides the supporting data as follows:
   a. Diagnosis or Differential Diagnosis: Bowel Obstruction
   b. Anatomic Location: Small bowel (jejunum)
   c. Classification of Criticality: Emergent
   d. Time Urgency: Acute
   e. Follow-Up Recommendations: Surgical Consultation
27. In addition to these standardized data requirements, the radiologist is requested by the program 110 to identify 1-4 “key images” in the collective imaging dataset which best visualize the critical result being reported. (In addition to selected “key images” from the current imaging dataset, the program 110 provides the option to also select comparable images from historical imaging datasets for inclusion in the “key image set”. This is of greatest value when a critical result is the result of interval worsening; in which prior and current key images best visualize the temporal change.)
28. These selected “key images” are then recorded by the program 110 in the critical results database 113 along with the accompanying standardized data. Collectively, this textual and imaging data include the “critical results data package” which is sent by the program 110 to the designated recipients for review and acknowledgment. (Note that in addition to text and imaging data, this data package may also include numerical and graphical data. Examples of critical results which would contain numerical and/or graphical data include abnormal laboratory results (i.e., numerical data) and progressively worsening blood pressure measurements (i.e., graphical data).
29. The combined “critical results data package” is automatically sent by the program 110 to the predefined and/or selected recipients. The predefined recipients are derived from the ordering data and primarily include the ordering clinician and their designated consultants. Selected recipients can be added by the program 110 or the user in accordance with the radiologist's critical results recommendations (e.g., on call general surgeon for bowel obstruction) or non-availability of the ordering clinician (e.g., ordering physician signed off to an “on call” colleague).
30. The specific method and options for communication are defined by the preferences of each individual end-user, institutional guidelines, and available technology.
31. Once the critical results data package has been sent by the program 110 (i.e., activation of the critical results communication pathway), the program 110 formally tracks and time stamps all actions related to data transfer, receipt, understanding, and other communications.
32. In this example of suspected bowel obstruction, the predefined requirement for communication receipt and understanding is 2 hours. If receipt acknowledgment by the intended recipient/s is not documented within this time period, an automated critical result communication escalation pathway is activated by the program 110 until receipt and understanding is successfully documented.
33. Once the critical results communication pathway has been activated by the program 110, the historical profiles of all predefined and selected recipients are retrieved and analyzed by the program 110 to assess historical compliance and timeliness of previous critical results communications.
34. This historical analysis serves 2 important purposes; first to gauge responsiveness and determine whether pre-emptive modifications to the critical results communication process need to be considered, and second, to define the most successful method of communication for those recipients (as measured by timeliness and understanding).
35. In this specific example, the on call surgeon (who is a designated recipient) has a well-established track record of being unavailable and delinquent in responding to critical results communications. As a result, the institution and department of surgery has requested that emergent critical results communications to that particular surgeon are given “accelerated status”; which include the following:
a. acceleration of the escalation pathway (from the pre-defined 2 hours to 1 hour);
b. simultaneous notification of the surgical department chief;
   c. notification of the reporting radiologist and ordering physician to present them with the option of modifying the designated recipients.
36. The on-call surgeon fails to acknowledge receipt of the critical results communication within the modified 1 hour time frame, and this triggers an emergent alert by the program 110 to the surgical department chief.
37. The surgical department chief acknowledges receipt of this “failure to acknowledge receipt” alert by the program 110, and in turn elects to take over the case (i.e., transfer of responsibility) as the primary consulting surgeon.
38. Upon taking over surgical responsibility, the surgical department chief formally acknowledges receipt and understanding of the critical results data package sent by the program 110. Upon doing so, the escalation pathway is terminated by the program 110 and successful communication is recorded by the program 110 in the critical results communication database 113 (with the corresponding data, identities, and times of all communications and participants recorded).
39. While acknowledging receipt and understanding of the critical results communication, the surgeon also requests a radiologist consultation, with the following options:
   a. Direct telephone communication;
   b. Synchronous electronic communication with review of key images;
   c. Asynchronous electronic communication through text alone.
40. The surgeon selects the option for “direct telephone conversation”, where the program 110 provides a direct dial number to the radiologist, along with the critical results data package for review. (Note that once a radiologist consultation has been requested by the surgeon, the critical results communication pathway is “reactivated” by the program 110, since additional communication is required. In doing so, a secondary critical result communication pathway is activated by the program 110 which provides a comparable requirement for receipt acknowledgment and understanding before it can be satisfactorily closed and the communication pathway terminated.)
41. The surgeon and radiologist discuss the case while referring to the key images and associated data contained in the data package. Collectively they come to the conclusion that the patient needs emergent surgery and that no further communication is required. At this point in time, both parties terminate the consultation and the secondary communication pathway is successfully terminated by the program 110 (with time stamped data recorded in the critical results communication database 113).
42. At this point in time, the surgeon activates a third critical results communication of the program 110, with the on-call operating room nurse and hospital administrator (i.e., designated recipients). In this critical results communication, the original critical results data package is sent by the program 110, along with additional text data provided by the surgeon stating “emergency surgery for bowel obstruction required, please arrange for surgery in 90 minutes”.
43. The operating room (OR) nurse confirms receipt and understanding of the critical result communication within 10 minutes of transmission and subsequently mobilizes the on-call surgical staff.
44. This critical result receipt confirmation and follow-up message is sent by the program 110 to the surgeon, on-call hospital administrator, and physician ordering the initial abdominal CT exam. By duplication of this critical result communication and follow-up; all involved parties are notified by the program 110 and included in the critical results communication pathway.
45. The operating room is mobilized within the requested 90 minute time frame and the surgery proceeds as planned.
46. During the course of surgery, the surgeon discovers that the cause of the severe abdominal pain was not an acute bowel obstruction, but actually was due to mesenteric ischemia.
47. Associated operative data (i.e., intra-operative photographs and the operative report) are attached to the original critical results data package and recorded by the program 110 in the critical results communication database 113 for the purpose of providing clinical outcomes data while also serving to address the clinical discrepancy between the original critical results communication and operative diagnoses (i.e., critical results QA discrepancy).
48. Once a critical results QA discrepancy is documented by the program 110, a formal review and retrospective analysis of the critical results data is required. This necessitates critical results data review by the original radiologist, surgeon, and designated radiology and surgical peers.
49. The combined group is tasked with issuing a report which addresses the discrepancy and identifies specific data causing confusion and/or misdiagnosis. In the event that additional key images are identified which shed light on the final diagnosis, these are included by the program 110 in the critical results data package and QA review.
50. The data, identities of participants, and time stamped events are all recorded by the program 110 in the critical results database 113; thereby creating a critical results timeline of the entire decision making process, intervention, and evaluation, from beginning to end.

B. QA and Economic Analysis of the Critical Results Database

As a result of a recent medical malpractice lawsuit (and settlement with the plaintiff), a hospital's malpractice insurance rates increased 30%. In the case in question, a suspicious lung 1 cm nodule was reported on a chest x-ray report with the recommendation for chest CT follow-up which was not acted upon. Two years later, the patient presented with a worsening cough and on chest x-ray was found to have enlargement of the same lung nodule, which now measured 2.5 cm. After bronchoscopy and biopsy, the nodule was found to represent a lung malignancy with metastases, requiring chemotherapy. The lawsuit alleged that timely action and follow-up to the original chest radiograph report could have led to early diagnosis and cure.

After discussing the case with hospital attorneys, the hospital administrator decided that a thorough and comprehensive quality assurance (QA) was required to quantify financial and medico-legal risk, while proactively improving quality and clinical outcomes. Since the greatest risk was associated with actionable “critical results”, the hospital administrator created a QA team comprised of medical, nursing, administrative, and IT leadership to identify existing enterprise-wide quality deficiencies and create a plan for systematic accountability and intervention.

The committee began by studying existing critical results communication practices in the hospital enterprise, with the hopes of identifying individual and systemic outliers for targeted improvement. While a critical results communication did exist, many committee members argued that quality standards in everyday practice were often lacking and little oversight was in place to identify outliers and proactively intervene when the defined standards were not maintained. At the same time, information technology (IT) staff recognized that critical results data was often not being recorded, and when doing so, the data recorded was often haphazard and inconsistent. After presenting the results to hospital management, it was decided to invest in a comprehensive critical results communication technology package, which mandated that all critical results be recorded in a standardized database 113, which would provide the requisite infrastructure for longitudinal data analysis and intervention at the point of care, with the hopes of improving quality and clinical outcomes.

In order to quantify a return on investment (ROI) for the critical results communication technology (i.e. the program 110 of the present invention), quality assurance nursing specialists were assigned the task of collecting and analyzing critical results communication data before and after implementation of the invention. Baseline hospital data relating to critical results communication was retrospectively collected over the prior 2 years (using random sampling of hospital records including hospital discharge summaries, operative reports, physician orders, progress notes, radiology and pathology reports, emergency room records, and admission history and physical reports. This data would be subsequently compared using the program 110, with prospective data collected using the critical results communication database 113, with an attempt to record and analyze comparable data whenever possible.

The list of variables for analysis included the following:
1. Accuracy: Where critical results being accurately detected at the time of diagnosis?
2. Consistency: What was the degree of inter and intra-observer variability in accurately detecting and characterizing critical results?
3. Context-Specificity: What specific types of findings or diagnoses were the most commonly missed or incorrectly identified?
4. Accountability: Within the hospital enterprise, what specific departments and individual stakeholders were more likely to err in critical results identification, reporting, and intervention? What effective checks and balances were in place to identify and intervene?
5. Timeliness: What specific time constraints existing with regards to critical results communication and follow-up action? What specific factors contributed to time delays?
6. Technology: How and what technology was available and being used in the communication process? How often was technology causative or a contributing factor to faulty critical result communication?
7. Classification: Were critical results being accurately classified upon recognition; specifically relating to criticality and time urgency?
8. Intervention: When follow-up recommendations were made in association with the critical results communication, were they accurately and reliably acted upon?
9. Clinical Outcomes: Upon recognition of a critical result, was the eventual clinical outcome consistent with, exceed, or lag community standards?
10. Feedback: What methods existing to provide data-driven feedback to service providers relative to their individual and collective performances of critical results communication? If and when this feedback is provided, does performance improve?

While the retrospective analysis was somewhat limited by available resources, relatively small sample size, and manual data collection; a number of observations were made which identified a number of individual and system-wide deficiencies related to critical results communication. These included the following:
1. Accuracy: Prospective identification of critical results was inconsistent and often poor, specifically relating to the category of “clinically unexpected”. In over 30% of the case of some unexpected radiology (e.g., mass) and laboratory (e.g., excessively elevated) findings, critical results were recorded but not communicated.
2. Consistency: A high degree of both inter and intra-observer variability was identified relating to critical result detection and communication. In many instances of intra-observer variability, critical results communication was found to be lowest at times of higher workload and end of shift.
3. Context-Specificity: A common example of a critical result finding which was frequently missed, incorrectly diagnosed, or not effectively communicated was related to acute abdominal pain. In analysis of both ER and radiology reports, certain critical results diagnoses of acute abdominal pain (e.g. ischemic bowel, bowel obstruction, and appendicitis) were often misdiagnosed.
4. Accountability: While accountability concerns existed at multiple individual and departmental levels, a number of individual service providers were habitual offenders. In the absence of rigorous and consistent data collection, these outliers largely went unnoticed.
5. Timeliness: A frequent source of dysfunctional critical results communication was often related to delayed communication; which was often attributed to outsourcing of critical results communication responsibilities to non-physician third parties.
6. Technology: The lack of supporting technology was found to be a contributing factor to the poor critical results communication; specifically related to lack of data standardization, creation of a centralized database for longitudinal analysis, and inability to detect outliers.
7. Classification: The lack of data standardization resulted in a myriad of ways in which critical results data was documented and classified. In the absence of a uniform classification schema, critical results were often reported using descriptive free text, which limited case by case comparison.
8. Intervention: Follow-up recommendations were frequently delayed, which could be in part be attributed to third party intervention in critical results communication, along with lack of standardized data.
9. Clinical Outcomes: The aforementioned lack of data standardization and small sample size of data analyzed limited effective analysis of clinical outcomes. Anecdotally, several emergent surgery critical result cases were identified where communication delays resulted in delayed intervention (i.e., time to surgery) and the possibility of prolonged post-operative recovery.
10. Feedback: The lack of a standardized database and derived analytics resulted in a system devoid of objective feedback and educational resources. Outliers continued to practice “as is” resulting in repetitive errors and delayed communication.

While the retrospective analysis was arguably deficient in many ways, the longitudinal analysis following implementation of the program 110 of the present invention, demonstrated objective improvement in critical results communication through enhanced accountability, data-driven feedback, establishment of “best practice” guidelines, standardized data, decision support and educational tools, and computer-driven escalation pathways. When presented with objective data, the majority of outliers (on both individual and departmental levels) were observed to improve performance. By demonstrating objective quality improvements in practice, the hospital was able to reduce malpractice insurance costs, improved operational efficiency, and market more effectively to consumers; all of which was shown to provide economic benefit and a positive ROI for the technology implemented.

Novel features of the proposed critical results communication technology of the present invention include:
1. Automated and manual triggering options.
2. Computerized analysis of reports with automated feedback prompts.
3. Customization of notification pathways in accordance with institutional and individual provider profiles.
4. Creation of standardized data requirements (e.g., clinical significance, follow-up recommendations, anatomic location).
5. Direct integration of imaging and textual data into critical results communication.
6. Integration of biometrics for authentication and identification of end users.
7. Ability to create finding-specific critical results macros.
8. Ability to integrate clinical orders and actions into communication schema (e.g., surgery consultation, scheduling of follow-up imaging exam).
9. Longitudinal tracking of clinical data in response to critical results communication (e.g., pathology report, lab data, operative report).
10. Electronic time stamped documentation of transmission, receipt, acknowledgment, and understanding.
11. Ability to perform multi-directional consultation and treatment planning using critical results data.
12. Ability to incorporate associated imaging and clinical data into the critical results communication (e.g., historical imaging data, laboratory data, history and physical data).
13. Options for creation of user defined sub-categories of critical results communications (e.g., emergent finding response time requirements: a. hyper-acute [<30 minutes] b. acute [<2 hours] c. sub-acute [<48 hours]).
14. Customization options for methods of communication based upon recipient end-user profiles (e.g., phone, instant messaging, e-mail alerts).
15. Integration of communication auto-routing protocols based upon physician availability and location (e.g., surgeon in operating room; emergent critical results auto-routed to cross covering surgeon, unexpected results auto-routed to office nurse).
16. Automated hierarchical notification schema based upon criticality and time urgency of critical results communication (e.g., 1-30 minutes primary care physician, 31-60 minutes pulmonary consultant, 61-90 minutes department chief, >91 minutes hospital administrator on call).
17. Ability to transmit parallel notification pathways in selected circumstances requiring immediate follow-up actions (e.g., primary care physician and surgeon on call for tension pneumothorax).
18. Option for simultaneous patient (or designated caregiver) notification (with ability to create patient-specific critical results data templates).
19. Creation of standardized critical results communication database containing clinical, communication, and outcomes data.
20. Ability to perform finding-specific, institutional, and individual provider analytics on critical results data for local quality improvement.
21. Ability to co-mingle multi-institutional critical results communication data (i.e., meta-analysis) for creating best practice and standardized practice guidelines.
22. Continuous analysis of individual provider actions and timeliness for critical results accountability analysis, with ability to utilize this data for education, disciplinary action, and modification of communication protocols.
23. Integration of computerized decision support features (e.g., follow-up recommendations, differential diagnosis).
24. Automated prompts and alerts on incomplete follow-up actions and outcomes data.
25. Integration capabilities with other information system technologies and ordering systems (e.g., immediate ordering of recommended imaging exam or laboratory study).
26. Electronic tracking tools to monitor end-user availability and reprioritize communication schema commensurate with availability.
27. Electronic confirmation of receipt acknowledgment and understanding.
28. Ability to link extraneous data to primary critical communication data (e.g., imaging, graphical, pictorial, numerical, textual data).
29. Feedback options provided from recipient of communication which not only acknowledges receipt but also provides feedback related to understanding of data, agreement, additional clinical information, or request for consultation.
30. Ability to transmit data using multiple simultaneous transmission options, in keeping with recipient profile/preferences and finding classification/urgency.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of implementing a medical critical results communication, comprising:
receiving an identification and a classification of a finding of criticality on a patient, from a health care provider sender, and storing said identification and said classification of said finding in a database of a computer system;
creating a critical results communication in said database, using a processor of the computer system;
transmitting said critical results communication to a recipient by a predetermined electronic mode of communication using the computer system;
receiving an acknowledgement from said recipient that said critical results communication was received and storing said acknowledgement in said database;
receiving feedback and/or initiation of clinical intervention and a follow-up action from said recipient, storing said feedback and/or initiation of clinical intervention and said follow-up action in said database;
transmitting said feedback and/or initiation of clinical intervention and follow-up action to said health care provider sender in a response from said recipient;
receiving diagnostic confirmation from said recipient and/or said healthcare provider sender, regarding the patient, and storing said diagnostic confirmation in said database;
performing an analysis of critical results data in said database using said processor, and performing an analysis of compliance with stored established medical standards; and
providing said critical results data analysis and said compliance analysis to said at least health care provider sender.

2. The method of claim 1, further comprising:
receiving a request from said recipient and arranging for additional consultation with at least one other health care provider regarding the patient.

3. The method of claim 2, further comprising:
incorporating medical imaging data into said critical results communication.

4. The method of claim 3, further comprising:
customizing data presentation of said medical imaging data for each said recipient tied to authentication and identification of each said recipient.

5. The method of claim 3, further comprising:
time stamping transmission of said critical results communication; and
recording said criticality and an urgency of said finding on said patient, methods of data transmission to and from said recipient, and identities of said health care provider sender and said recipient, in said database.

6. The method of claim 4, wherein said authentication and identification is obtained by biometrics.

7. The method of claim 1, further comprising:
instituting an escalation communication pathway when said recipient does not acknowledge receipt within a predetermined time period.

8. The method of claim 5, wherein information on said recording of said criticality and said urgency of said finding, and on said feedback and/or initiation of clinical intervention and said follow-up action from said recipient, or said arrangement for additional consultation, is included in said critical results communication and said response from said recipient.

9. The method of claim 8, further comprising:
linking, using said processor, said follow-up action from said recipient with resulting orders from said clinician, such that said recipient may review and approve of said resulting orders.

10. The method of claim 9, further comprising:
issuing another critical results communication via said electronic mode of communication, when said resulting orders are approved by said recipient; and
linking, using said processor, said medical imaging data with said another critical results communication.

11. The method of claim 1, wherein said critical results communication is activated by the processor upon a predetermined threshold of said criticality of said finding.

12. The method of claim 5, wherein said critical results communication includes mandatory standardized data fields, said data fields including said finding, said classification, said urgency, said follow-up action, and an anatomic location.

13. The method of claim 12, further comprising:
adding non-standardized data or linking ancillary data, to said critical results communication.

14. The method of claim 13, further comprising:
instituting a technical escalation pathway when technical issues arise in said transmission of said critical results communication.

15. The method of claim 7, wherein said critical results data analysis is performed in performed in real-time, and said real-time critical results data analysis is used to create customizable interventions, including at least real-time modifications to said escalation communication pathway.

16. The method of claim 11, further comprising:
integrating a standardized system for documenting understanding of said critical results communication, including providing a plurality of responses for said recipient regarding understanding of said critical results communication.

17. The method of claim 16, further comprising:
integrating a consultation tool into workflow of an end user, commensurate with individual preferences and said criticality of said critical results data.

18. The method of claim 17, wherein said consultation tool requires completion of said additional consultation before any computer-based actions can be performed by said end user.

19. A non-transitory computer-readable medium containing executable code for implementing a medical critical results communication, comprising:
receiving an identification and a classification of a finding of criticality on a patient, from a health care provider sender, and storing said identification and said classification of said finding in a database of a computer system;
creating a critical results communication in said database, using a processor of the computer system;
transmitting said critical results communication to a recipient by a predetermined electronic mode of communication using the computer system;
receiving an acknowledgement from said recipient that said critical results communication was received and storing said acknowledgement in said database;
receiving feedback and/or initiation of clinical intervention and a follow-up action from said recipient, storing said feedback and/or initiation of clinical intervention and said follow-up action in said database;
transmitting said feedback and/or initiation of clinical intervention and follow-up action to said health care provider sender in a response from said recipient;
receiving diagnostic confirmation from said recipient and/or said healthcare provider sender, regarding the patient, and storing said diagnostic confirmation in said database;
performing an analysis of critical results data in said database using said processor, and performing an analysis of compliance with stored established medical standards; and
providing said critical results data analysis and said compliance analysis to said at least health care provider sender.

20. A computer system which implements a critical results communication, comprising:
at least one memory which contains at least one program which comprises the steps of:
receiving an identification and a classification of a finding of criticality on a patient, from a health care provider sender, and storing said identification and said classification of said finding in a database of a computer system;
creating a critical results communication in said database, using a processor of the computer system;
transmitting said critical results communication to a recipient by a predetermined electronic mode of communication using the computer system;
receiving an acknowledgement from said recipient that said critical results communication was received and storing said acknowledgement in said database;
receiving feedback and/or initiation of clinical intervention and a follow-up action from said recipient, storing said feedback and/or initiation of clinical intervention and said follow-up action in said database;
transmitting said feedback and/or initiation of clinical intervention and follow-up action to said health care provider sender in a response from said recipient;
receiving diagnostic confirmation from said recipient and/or said healthcare provider sender, regarding the patient, and storing said diagnostic confirmation in said database;
performing an analysis of critical results data in said database using said processor, and performing an analysis of compliance with stored established medical standards; and
providing said critical results data analysis and said compliance analysis to said at least health care provider sender; and
at least one processor for executing the program.
